(19) United States
(12) Patent Application Publication
(10) Pub. No.: US 2013/0087505 A1
(43) Pub. Date: Apr. 11, 2013

(54) Travelling Field Reactor and Method for Separating Magnetizable Particles From a Liquid

(71) Applicants: Vladimir Danov, Erlangen (DE); Bernd Gromoll, Baiersdorf (DE); Werner Hartmann, Weisendorf (DE); Andreas Schröter, Anrode (DE)

(72) Inventors: Vladimir Danov, Erlangen (DE); Bernd Gromoll, Baiersdorf (DE); Werner Hartmann, Weisendorf (DE); Andreas Schröter, Anrode (DE)

(21) Appl. No.: 13/702,682

(22) PCT Filed: May 5, 2011
(86) PCT No.: PCT/EP2011/057229

§ 371 Date: Dec. 7, 2012

(30) Foreign Application Priority Data
Jun. 9, 2010 (DE) 10 2010 023 130.4

(51) Int. Cl. B03C 1/253

(52) U.S. Cl. CPC B03C 1/253
USPC 210/695; 210/222; 210/223

(57) ABSTRACT

A travelling field reactor and a method for separating magnetizable particles from a liquid using said travelling field reactor are disclosed. The travelling field reactor may include a tubular reactor, the outer circumference of which is provided with at least one magnet for producing a travelling field and through the interior of which the liquid flows. A displacement element may be located in the interior of the tubular reactor, said element admitting a liquid into the interior of the tubular reactor, which mixes with the liquid flowing in the reactor.

### CROSS-REFERENCE TO RELATED APPLICATIONS

This application is a U.S. National Stage Application of International Application No. PCT/EP2011/057229 filed May 5, 2011, which designates the United States of America, and claims priority to DE Patent Application No. 10 2010 023 130.4 filed Jun. 9, 2010 The contents of which are hereby incorporated by reference in their entirety.

### TECHNICAL FIELD

The present disclosure relates to a traveling field reactor and to a method for separating magnetizable particles from a liquid using the traveling field reactor. The traveling field reactor comprises a tubular reactor, on the outer circumference of which at least one magnet for producing a traveling field is disposed and through the interior of which the liquid can flow. A displacement element is disposed in the interior of the tubular reactor.

### BACKGROUND

Traveling field reactors, as known for example from WO 2010/031613 A1, are used to separate magnetizable particles or magnetic particles from a liquid. The term magnetizable particles also covers magnetic particles, which are already magnetized. Magnetizable particles result for example during ore processing, when the iron ore bearing rock is ground finely for example. To separate the metal to be extracted, e.g. magnetite (Fe₃O₄), from the rest of the material, e.g. sand, the ground rock is mixed with water or oil. Magnetizable particles are then separated from the mixture in traveling field reactors, using magnetization and the directed movement of the particles in magnetic fields.

Prefabricated magnetizable particles can also be used to extract compounds from ore, by using for example chemically functionalized or physically activated magnetizable particles. The components to be extracted from the ore can be bonded to the particles chemically, e.g. by way of sulfidic bonding, or physically, e.g. by way of Coulomb interaction. Similarly magnetizable particles can also be used to separate trace materials from a solution, solids from a suspension or liquids having different phases from one another.

During separation of the magnetizable particles from the liquid the mixture is pumped or flows through a tubular reactor, for example using the force of gravity. The reactor is enclosed by electromagnetic coils or permanent magnets, which produce a magnetic field in the interior of the reactor. The magnetic field acts on the magnetizable particles in the liquid. The action of the magnetic field causes the magnetizable particles to move in the direction of the wall, i.e. the inner wall of the tubular reactor. The electromagnetic coils or permanent magnets produce a traveling field along the longitudinal direction of the tubular reactor, in other words the magnetic field changes amplitude so that the amplitude of the magnetic field travels in a wave-like manner in time and space along the longitudinal direction or in the direction of the liquid flow.

The action of the traveling field causes the magnetizable particles moved onto the wall to collect in agglomerations and move along the wall in the direction of the longitudinal axis of the reactor or with the flow. Disposed in the wall in an end region of the reactor are suction openings, which can be opened and closed again in a controlled or regulated manner. When the suction openings are open, the particles can be sucked out of the reactor. The remaining liquid with or without a greatly increased particle concentration is discharged or pumped out of the reactor by way of a tube outlet of the tubular reactor.

To separate the liquid and the particles moved on the wall more effectively, an annular separating diaphragm can be disposed in the region of the suction openings. It is disposed in the manner of a tube section with a smaller external diameter in the tube of the tubular reactor with a larger internal diameter. Formed between the separating diaphragm tube section and the reactor tube is a gap, which is sufficiently large to allow the agglomerations of magnetizable particles to move through the gap along the wall in the region of said gap. The gap is small enough to allow only as little liquid as possible to flow through the gap with the magnetizable particles moved along the wall. The remaining liquid, which contains no magnetizable particles or at least a reduced concentration of magnetizable particles, flows through the inner region of the separating diaphragm, which is completely enclosed by the annular separating diaphragm, to the tube outlet of the tubular reactor.

The magnetizable particles in the gap can be discharged or sucked out directly by way of a gap outlet, or suction openings in the wall can be used to suck out the magnetized particles in the gap in a controlled or regulated manner.

To achieve effective separation of magnetizable particles and liquid, high field strengths have to be used for the magnetic fields, in order to be able to penetrate the inner region along the cross section of the tubular reactor completely with the magnetic field. Only in this way can all or at least a majority of the magnetizable particles be moved onto the wall of the reactor.

It is possible to improve the separation effect for smaller fields and therefore the energy saving when using electrical coils to produce the magnetic fields by using a displacement element. The displacement element is disposed for example in a cylindrical manner in the hollow cylindrical or tubular reactor, e.g., in the center when viewed in cross section. The liquid flows in the gap between reactor wall and displacement element and the flow cross section is restricted from a round circular to a round annular cross section. Other cross sections apart from round are also conceivable. For complete penetration of the annular gap between displacement element and tubular reactor wall, in which the liquid containing magnetizable particles flows, with the magnetic field, weaker magnetic field strengths are required than for complete penetration of the tubular reactor without displacement element.

The traveling field reactor described above results in effective separation of magnetizable particles and liquid. However the concentration of the magnetizable particles increases in a pulsed manner as a function of the separating diaphragm geometry and as a function of the flow and traveling field speed. A flow of reusable material, which includes the magnetizable particles, is therefore extracted not continuously but quasi continuously in a pulsed manner from the reactor.

In addition to the magnetizable particles a certain quantity of liquid mixed with the particles is also sucked out. This liquid contains ore residues, or tailing. To reduce the tailing concentration further, the concentrated particle/liquid mixture can be pumped repeatedly through traveling field reactors. However this increases costs and time outlay and causes the liquid to become viscous.

### SUMMARY

In one embodiment, a traveling field reactor is provided for separating magnetizable particles from a liquid, having a tubular reactor, on the outer circumference of which at least one magnet for producing a traveling field is disposed and through the interior of which the liquid can flow, wherein a displacement element is disposed in the interior of the tubular reactor, wherein the displacement element is configured to introduce liquid into the interior of the tubular reactor.

In a further embodiment, the displacement element is configured as a pipe, through which liquid can flow and at the one end of which at least one opening for introducing the liquid into the interior of the tubular reactor is disposed in the interior of the tubular reactor. In a further embodiment, the at least one opening is configured in the form of a nozzle. In a further embodiment, a separating diaphragm is disposed at the one end of the displacement element in the interior of the tubular reactor, which is configured to separate magnetizable particles, which can be moved along a wall of the tubular reactor, from liquid in the interior of the reactor away from the wall. In a further embodiment, the at least one opening for introducing the liquid into the interior of the tubular reactor is disposed in the separating diaphragm. In a further embodiment, the separating diaphragm is configured in the shape of a hollow cylinder, with webs between the one end of the displacement element in the interior of the tubular reactor and the separating diaphragm, in particular with tubular webs, which connect the displacement element and the separating diaphragm fluidically. In a further embodiment, the separating diaphragm and displacement element are configured from a homogeneous element. In a further embodiment, the tubular reactor and/or displacement element are configured in the shape of hollow cylinders, with a circular cross-sectional area. In a further embodiment, the at least one opening is disposed on a circumference, in particular that six openings are disposed on the circumference, at the points where the circumference intersects with a beam pair going out from the center of the circle, the beam pairs forming an angle of 60°, 120°, 180°, 240° and 300° respectively. In a further embodiment, the liquid contains water and/or oil or consists essentially of water and/or oil. In a further embodiment, the at least one magnet for producing a traveling field, which is disposed on the outer circumference of the tubular reactor, comprises an electromagnet and/or a permanent magnet.

In another embodiment, a method is provided for separating magnetizable particles from a liquid using a traveling field reactor as claimed in one of the preceding claims, wherein a second liquid, in particular water, is conducted through a tubular displacement element into the interior of a tubular reactor, through which a first liquid, in particular a suspension of magnetizable particles and water, flows.

In a further embodiment, the first liquid flows in an intermediate space between the displacement element and a wall of the tubular reactor in the interior of the tubular reactor along a longitudinal axis of the tubular reactor and the second liquid flows from the interior of the tubular displacement element by way of tubular webs at one end of the tubular displacement element to at least one opening, in particular to 6 nozzle-type openings, in a separating diaphragm between displacement element and tubular reactor, with the first and second liquids mixing in a region between separating diaphragm and tubular reactor and the first liquid flowing between the webs, completely enclosed by the separating diaphragm. In a further embodiment, the flow of the first liquid and the flow of the second liquid meet in the region of the openings at an angle of essentially 90°. In a further embodiment, the first and second liquids are mixed using the counterflow principle and/or the first and second liquid are mixed in an identical flow direction, in particular with an eddying flow.

### BRIEF DESCRIPTION OF THE DRAWINGS

Example embodiments will be explained in more detail below with reference to figures, in which:

FIG. 1 shows a schematic sectional diagram along the flow direction of a liquid 5 in an traveling field reactor 1 according to an example embodiment, and

FIG. 2 shows a cross section through the traveling field reactor 1 from FIG. 1 in the region where a separating diaphragm 9 is fastened to a displacement element 6 by way of webs 11.

### DETAILED DESCRIPTION

Embodiments of the present disclosure provide a traveling field reactor for separating magnetizable particles from a liquid and a method for its use, which prevent the liquid becoming thick or viscous, thereby allowing more effective separation of particles and liquid with lower costs and outlay as well as a greater yield. Some embodiments of the traveling field reactor and method are able to extract a continuous flow of reusable material from the reactor.

In some embodiments a traveling field reactor for separating magnetizable particles from a liquid comprises a tubular reactor, on the outer circumference of which at least one magnet for producing a traveling field is disposed. The liquid can flow through the interior of the tubular reactor and a displacement element is located in its interior. The displacement element is configured to introduce liquid into the interior of the tubular reactor.

The liquid, which is conducted through the displacement element into the interior of the tubular reactor, dilutes the liquid containing magnetizable particles in the reactor. This additional liquid allows the flow of liquid containing magnetizable particles, which is removed or discharged from the reactor, to be changed from a pulsed to a continuous flow. The liquid containing magnetizable particles can be diluted for example using pure water or pure oil, depending on whether the initial liquid containing magnetizable particles contains water or oil. The diluted mixture can be supplied to a further reactor and dilution means that the mixture remains more liquid and can be processed more easily and can be further concentrated or cleaned. With every pass through a traveling field reactor tailing is removed and the concentration and purity in respect of desired particles of reusable material or reusable material bonded to particles increases. This increases the yield of reusable material to be extracted.

Dilution with liquid from the displacement element therefore increases the processability of the reusable material from the reactor and as the passes are repeated the improved viscosity of the liquid and the reduced particle density resulting from the dilution increase the particles' capacity for movement. Therefore in a further pass through a reactor magnetizable particles can be moved more effectively onto the wall in the magnetic field and can therefore be separated more effectively from the liquid containing tailing. More effective separation means that fewer passes are required to achieve a desired concentration of the particles and cleaning of tailing. This saves costs and outlay and increases yield.

In order to be able to supply liquid to the reactor by way of the displacement element, the displacement element can be configured as a pipe. Liquid can flow through the pipe and at least one opening for introducing the liquid into the interior of the tubular reactor can be disposed at one end of the pipe in the interior of the tubular reactor. This allows liquid from the displacement element to be added to the flow of liquid containing magnetizable particles in the tubular reactor in a spatial region in which the magnetizable particles are already combined as agglomerations on the wall by the magnetic traveling field. The addition of liquid and therefore the change in flow conditions, even the formation of eddies, therefore does not disrupt the process of movement of the magnetizable particles in the direction of the wall and agglomeration.

The liquid is emitted effectively from the displacement element into the tubular reactor, with a controllable or regulatable or predefinable flow shape, if the at least one opening is configured in the form of a nozzle. The liquid can thus be “injected” or introduced in a specific manner into the liquid flow containing magnetizable particles and the resulting flow and the mixing of the flows can be influenced favorably.

A separating diaphragm can be disposed in the interior of the tubular reactor at the one end of the displacement element. This can improve separation of magnetizable particles, which can be moved along a wall of the tubular reactor, from liquid in the interior of the reactor away from the wall. The magnetizable particles with a small quantity of liquid, in the following also referred to as residual liquid, can thus be moved along the gap between separating diaphragm and tubular reactor. The main flow of liquid, which contains no or only a few magnetizable particles, does not flow through the gap but centrally through the separating diaphragm. The separating diaphragm therefore separates the particle flow with residual liquid from the main flow without or with few magnetizable particles. There is no need for the magnetized particles to be sucked through suction openings in the wall of the reactor. Technical outlay is reduced. Even if suction openings are used, only the residual liquid containing magnetizable particles is sucked out, not the main flow of liquid, thereby separating the magnetizable particles from the liquid (main flow) more effectively in this instance.

The at least one opening for introducing the liquid into the interior of the tubular reactor can be disposed in the separating diaphragm. This means that the main flow of liquid leaving the reactor is not diluted, just the part that is residual liquid containing magnetizable particles, present between diaphragm and wall of the tubular reactor.

The separating diaphragm can be configured in the shape of a hollow cylinder or ring, with webs between the one end of the displacement element in the interior of the tubular reactor and the separating diaphragm. The webs can be tubular and can connect the displacement element and the separating diaphragm fluidically. This allows the main liquid without or with a greatly reduced concentration of magnetizable particles to flow between the webs, within or enclosed by the separating diaphragm, and to leave the reactor without being mixed once again with the residual liquid and the magnetizable particles. The residual liquid containing magnetizable particles can leave the reactor directly by way of the gap between separating diaphragm and wall of the reactor or can be discharged by way of openings in the wall without combining with the main flow again.

The hollow cylindrical shape of the separating diaphragm produces favorable flow conditions for the liquids in the region of the separating diaphragm. The hollow cylindrical shape with a longitudinal axis parallel to the flow direction of the liquid containing magnetizable particles before the diaphragm offers less flow resistance when the liquid enters in the region of the diaphragm, thereby allowing reduced pump output.

The separating diaphragm and displacement element can be configured from a homogeneous element. This provides a particularly mechanically stable structure. The material selected for the displacement element and the separating diaphragm may be a non-magnetic material. The material used can be plastic for example. As a result the magnetizable particles do not adhere to the separating diaphragm and displacement element and separation is not impeded and the magnetic fields for movement of the magnetizable particles are not disrupted.

The tubular reactor and/or displacement element can be configured in the shape of hollow cylinders, with a circular cross-sectional area. This provides a particularly simple structure and favorable flow conditions through the reactor, without major flow resistance, with a high level of mechanical stability.

The at least one opening can be disposed on a circumference. Rather than one opening, a number of openings are generally used in order to be able to introduce liquid by way of the supporting element in all regions of the gap between the wall of the reactor and the diaphragm. In one favorable embodiment six openings are disposed on the circumference, at the points where the circumference intersects with a beam pair going out from the center of the circle, the beam pairs forming an angle of 60°, 120°, 180°, 240° and 300° respectively. The openings are generally located directly at the end of the supports. The resulting structure is similar to that of a cartwheel with spokes, with the outlet openings at the ends of the spokes.

The liquid used can be for example water and/or oil, both for the liquid containing magnetizable particles and for the added liquid by way of the displacement element. When water is used for the liquid containing magnetizable particles (and tailing), water may also be used as the added liquid but this must be pure water. When oils are used for the liquid containing magnetizable particles (and tailing), oil may also be used as the added liquid, but this must be pure oil. The liquids can contain water or oil but also only as one component.

The at least one magnet for producing a traveling field, which is disposed on the outer circumference of the tubular reactor, can comprise an electromagnet and/or a permanent magnet. A magnetic traveling field can be produced in a simple and easily controlled manner by way of an electromagnet, which is made up of coils for example. Alternatively or additionally permanent magnets can also be used, with the permanent magnets being moved along the tubular reactor to produce a traveling field.

The disclosed method for separating magnetizable particles from a liquid with a traveling field reactor as described above comprises the steps in which a second liquid, in particular water, is conducted through a tubular displacement element into the interior of a tubular reactor. A first liquid, in particular a suspension of magnetizable particles and water, flows through the tubular reactor.

The first liquid can flow in an intermediate space between the displacement element and a wall of the tubular reactor in the interior of the tubular reactor along a longitudinal axis of the tubular reactor and the second liquid can flow from the interior of the tubular displacement element by way of tubular webs at one end of the tubular displacement element to at least one opening, in particular to 6 nozzle-type openings, in a separating diaphragm between displacement element and tubular reactor. In this process the first and second liquids can mix in a region between separating diaphragm and tubular reactor and the first liquid can flow between the webs, completely enclosed by the separating diaphragm.

The flow of the first liquid and the flow of the second liquid can meet in the region of the openings at an angle of essentially 90°. This allows particularly effective mixing to be achieved.

Alternatively the first and second liquids can be mixed using the counterflow principle. The first and second liquids can also be mixed in an identical flow direction, in particular with an eddying flow.

Certain advantages associated with the method for separating magnetizable particles from a liquid using a traveling field reactor are similar to the advantages described above in relation to the traveling field reactor.

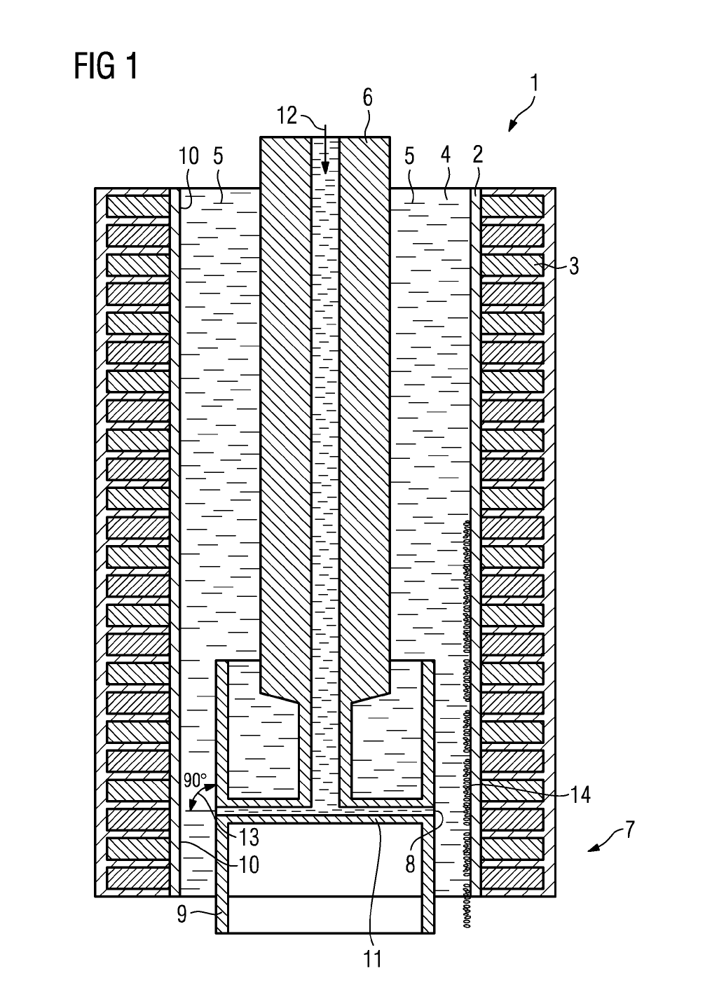

FIG. 1 shows a traveling field reactor 1 according to an example embodiment. The traveling field reactor 1 comprises a tubular reactor 2, which comprises for example a hollow cylindrical tube made of plastic or other non-magnetic materials. Disposed on the outer circumference of the tubular reactor 2 are magnets, e.g. electromagnets made from electrical coils. The coils are disposed along the outer circumference of the reactor 2 in such a manner that they are adjacent to one another along the longitudinal direction of the reactor 2, so that they can produce a magnetic traveling field in the interior 4 of the reactor 2.

The magnetic traveling field extends through the whole of the interior 4 of the reactor 2, in which liquid containing magnetizable particles 5 flows, along the cross section of the reactor 2 in the region of the magnets 3. The liquid containing magnetizable particles 5 flows with a flow direction parallel to the longitudinal direction of the tubular reactor 2 in the interior 4 of the reactor 2 and the magnetic field of the magnets 3 exerts a force on the magnetizable particles, which moves them in the direction of the inner wall 10 of the reactor 2. Embodying the magnetic field as a traveling field means that the magnetizable particles are moved along the wall 10, in flow direction 5. Depending on the embodiment of the traveling field the magnetizable particles can also be moved through the traveling field counter to the flow direction 5 if required. A magnetic traveling field in the following refers to a magnetic field, the amplitude of which “travels” over time or changes spatially, in other words is moved, in the manner of a wave along the longitudinal direction of the tubular reactor 2 over time.

Disposed in the center of the interior 4 of the tubular reactor 2, with a longitudinal axis parallel to or congruent with the longitudinal axis of the tubular reactor, is a displacement element 6. The displacement element 6 displaces liquid, thereby ensuring that the space 4 available for the liquid is reduced. For complete penetration of the reduced space 4 by the magnetic field, the magnets 3 have to be smaller as do the current strengths when electromagnets are used. This saves on outlay, materials and/or energy.

Like the tubular reactor 2 the displacement element 6 is configured as a hollow cylindrical tube but with a smaller outer circumference than the inner circumference of the tubular reactor 2. Formed between the outer circumference of the displacement element 6 and the inner circumference of the tubular reactor 2 is a gap or the interior 4, in which the liquid containing magnetizable particles 5, i.e. the first liquid, flows. A second liquid 12 flows in the interior of the hollow cylindrical tube of the displacement element 6, i.e. in the interior of the displacement element 6.

If the first liquid 5 is made from a finely ground iron ore suspended in water, then water, in particular pure water, can be used as the second liquid. In this instance the magnetizable particles are magnetite particles, which are magnetized in an outer magnetic field. Sand elements are also contained in the suspended mixture. If oil is used for the suspension, then oil, in particular pure oil, can be used as the second liquid. Solvents can also be used as liquid components or mixture of liquids.

The displacement element 6 is connected to a separating diaphragm 9 at one end 7 by way of webs 11. The separating diaphragm 9 is embodied in a hollow cylindrical, annular manner, with an outer circumference of the ring smaller than the internal diameter of the tubular reactor 2. The center axes of the annular or tubular separating diaphragm 9 and of the tubular reactor 2 can be parallel or even identical. This means that the separating diaphragm 9 offers little flow resistance to the flow of the first liquid 5. Formed between the wall 10, i.e. the inner wall of the tubular reactor 2, and the outer circumferential surface of the annular separating diaphragm 9 is a narrow continuous gap, through which the magnetizable particles moved by the traveling field on the wall 10 can be moved or can flow with a small quantity of first liquid 5. The majority of the first liquid 5, which contains no or only a small quantity of magnetizable particles, flows through the internal diameter of the separating diaphragm 9.

The magnetizable particles in the first liquid 5 are collected on the wall 10 by the magnetic field in the region of the tubular reactor in front of the separating diaphragm 9 and are thus depleted or completely eliminated in the central region, away from the wall 10. The separating diaphragm 9 “mechanically” separates the majority of the first liquid 5, which contains no or only a few magnetizable particles, from the magnetizable particles collected on the wall 10 with residual liquid 5. The magnetizable particles can be agglomerated in a traveling field, in other words they do not collect on the wall 10 in a regularly distributed manner but combine to form “piles”. The “piles” are then moved by the traveling field along the wall 10 to an outlet at the end 7 of the tubular reactor 2, separate from the outlet for the majority of the liquid 5, which is depleted or without magnetizable particles, and can be discharged, pumped out or made to flow out from the reactor 2 there with a small residual portion of liquid 5. The majority of the liquid 5 containing tailing, which has been depleted or completely liberated of reusable material (magnetizable particles) but contains a lot of undesirable residual ore (e.g. sand) components, can be removed, made to flow or be discharged from the reactor 2 in the central region, the inner region of the annular separating diaphragm 9.

As an alternative to removing the agglomerations of magnetizable particles 14 with a residual portion of liquid 5 by way of an outlet, openings can be disposed in the wall 10 of the tubular reactor 2, which can be opened as an agglomeration 14 passes through, thereby allowing the agglomerations 14 to be sucked out in a specific manner.

The increased proportion of magnetizable particles means that the residual liquid 5 containing magnetizable particles, which is removed from the reactor 2 through openings or from an outlet in the gap between separating diaphragm 9 and tubular reactor 2, is very thick or has a high viscosity. This can block openings or gap outlets and cause problems with further processing. Therefore a second liquid, e.g., a pure liquid, such as pure water or oil, is pumped, introduced or injected into the gap between separating diaphragm 9 and wall 10 of the tubular reactor 2. This dilutes the residual liquid 5 containing agglomerated magnetized particles 14, prevents blocking of the outlets or removal openings and facilitates the further processing of the magnetizable particles.

The second liquid for diluting can be supplied simply by way of the displacement element, as supplying by way of openings in the wall 10 of the tubular reactor 2 would cause problems with the movement of the magnetizable particles on the wall 10. As shown in FIG. 1, the second liquid is conveyed, conducted or pumped by way of the inner part of the tubular displacement element 6, by way of tubular webs 11 to openings 8 in the separating diaphragm 9 and introduced into the gap between separating diaphragm 9 and wall 10 of the tubular reactor 2 from the openings. This causes the first liquid 5 containing magnetizable particles to be diluted by the second liquid 12 in the region of the gap.

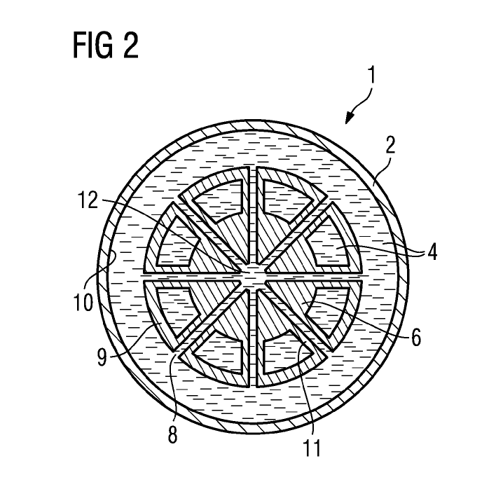

For a better illustration FIG. 2 shows the region of the tubular reactor 2 with separating diaphragm 9, webs 11 and displacement element 6 in cross section, perpendicular to the section illustrated in FIG. 1 along the axis of the tubular reactor 2 or the displacement element 6.

The annular separating diaphragm 9 is connected in a mechanically stable manner by way of the webs 11 to the displacement element 6. Between the webs 11 is space, by way of which the majority of the liquid without or with a greatly reduced concentration of magnetizable particles can be conducted away or can flow through the interior 4 of the annular separating diaphragm 9. Configured between separating diaphragm 9 and wall 10 of the tubular reactor 2 is the gap, which produces an interior 4 or an intermediate space, by way of which the agglomerated magnetizable particles 14, which are moved along the wall 10, can be removed from the reactor 2 and in which second liquid 12 is added or mixed for dilution purposes. The second liquid 12 is supplied by way of the tubular displacement element 6, by way of tubular webs 11 connected fluidically thereto, to the openings 8 in the separating diaphragm 9, which can be configured in the form of nozzles. The second liquid 12 is introduced into the gap between wall 10 of the tubular reactor 2 and separating diaphragm 9 by way of the openings 8. The webs 11 thus connect the displacement element 6 to the separating diaphragm 9 or to regions of the openings 8 in the separating diaphragm 9 in a mechanically stable and fluidic manner. The separating diaphragm 9, the webs 11 and the displacement element can be configured from a homogeneous element.

As shown in FIG. 1, the second liquid 12 for diluting can be introduced into the gap at a right angle 13 to the surface of the wall 10 or of the separating diaphragm 9 or to the flow direction 5 of the first liquid. This results on the one hand in an overall flow of liquid 5, 12, which allows effective mixing of the liquids 5, 12, e.g. by forming eddies. It also results in a sub-flow in the gap, which counters the entry of liquid 5 containing tailing, thereby improving the separation of magnetizable particles from the tailing. The movement of the magnetizable particles is only impeded in certain circumstances or not at all by the flow, as it is determined essentially by the traveling field as a function of the gap width.

As an alternative to an angle 13 of 90°, other angles are also conceivable. It is thus possible, by selecting appropriate angles for example, to achieve counterflows or flows in an identical direction for the liquids 5 and 12.

The invention is not limited to the embodiments described above. Embodiments can also be combined with one another. In particular a number of difference substances can be used as liquids and particles.

What is claimed is:

1. A traveling field reactor for separating magnetizable particles from a liquid, comprising:
a tubular reactor comprising:
at least one magnet located on an outer circumference of the tubular reactor and configured to produce a traveling field,
an interior configured to communicate a liquid flow through the tubular reactor, and
a displacement element disposed in the interior of the tubular reactor,
wherein the displacement element is configured to introduce liquid into the interior of the tubular reactor.

2. The traveling field reactor of claim 1, wherein the displacement element is configured as a pipe through which liquid can flow and having at least one opening at one end for introducing the liquid into the interior of the tubular reactor.

3. The traveling field reactor of claim 2, wherein the at least one opening is embodied as a nozzle.

4. The traveling field reactor of claim 2, wherein a separating diaphragm is disposed at the one end of the displacement element in the interior of the tubular reactor, the separating diaphragm being configured to separate magnetizable particles, which can be moved along a wall of the tubular reactor, from liquid in the interior of the reactor at locations away from the wall.

5. The traveling field reactor of claim 4, wherein the at least one opening for introducing the liquid into the interior of the tubular reactor is disposed in the separating diaphragm.

6. The traveling field reactor of claim 4, wherein the separating diaphragm comprises a hollow cylinder shape, with webs located between the one end of the displacement element in the interior of the tubular reactor and the separating diaphragm, the webs configured to fluidically connect the displacement element and the separating diaphragm.

7. The traveling field reactor of claim 4, wherein the separating diaphragm and the displacement element from an integral element.

8. The traveling field reactor of claim 1, wherein at least one of (a) the tubular reactor and (b) the displacement element is configured in the shape of a hollow cylinder with a circular cross-sectional area.

9. The traveling field reactor of claim 2, wherein, in a cross-section of the tubular reactor that defines a circle, the at least one opening comprises six openings disposed on a circumference of the circle at points where the circumference intersects with a respective one of six beam pairs extending from a center of the circle, the six beam pairs being spaced evenly around the circumference of the circle.

10. The traveling field reactor of claim 1, wherein the liquid contains water and/or oil.

11. The traveling field reactor of claim 1, wherein the at least one magnet for producing a traveling field comprises at least one of an electromagnet and a permanent magnet.

12. A method for separating magnetizable particles from a liquid using a tubular reactor, comprising:
producing a traveling field using at least one magnet located on an outer circumference of the tubular reactor,
communicating a first liquid through an interior of the tubular reactor,
using a tubular displacement element disposed in the interior of the tubular reactor to introduce a secong liquid into the interior of the tubular reactor.

13. The method of claim 12, wherein:
the first liquid flows in an intermediate space between the displacement element and a wall of the tubular reactor in the interior of the tubular reactor along a longitudinal axis of the tubular reactor, and
the second liquid flows from the interior of the tubular displacement element by way of tubular webs at one end of the tubular displacement element to at least one opening in a separating diaphragm between displacement element and tubular reactor, with the first and second liquids mixing in a region between separating diaphragm and tubular reactor and the first liquid flowing between the webs, completely enclosed by the separating diaphragm.

14. The method of claim 13, wherein the flow of the first liquid and the flow of the second liquid meet in a region of the openings at an approximately 90° angle.

15. The method of claim 13, wherein the first and second liquids are mixed using the counterflow principle and/or the first and second liquid are mixed in an identical flow direction, in particular with an eddying flow.

16. The method of claim 13, wherein the first and second liquid are mixed in an identical flow direction, with an eddying flow.

17. The method of claim 12, wherein:
the first liquid comprises a suspension of magnetizable particles and water, and
the second liquid comprises water.
